(19) United States
(12) Patent Application Publication
(10) Pub. No.: US 2025/0172339 A1
(43) Pub. Date: May 29, 2025

(54) HEAT TREATMENT SYSTEM

(71) Applicants: NGK INSULATORS, LTD., Nagoya-Shi (JP); NGK KILNTECH, CORPORATION, Nagoya-Shi (JP)

(72) Inventors: Masato OBATA, Nagoya-Shi (JP); Minoru YAMAGUCHI, Nagoya-Shi (JP); Tomoaki OYAMA, Nagoya-Shi (JP)

(73) Assignees: NGK INSULATORS, LTD., Nagoya-Shi (JP); NGK KILNTECH, CORPORATION, Nagoya-Shi (JP)

(21) Appl. No.: 18/915,604

(22) Filed: Oct. 15, 2024

(30) Foreign Application Priority Data
Nov. 29, 2023 (JP) 2023-201726

(51) Int. Cl. F27B 9/24; F27B 9/32

(52) U.S. Cl. CPC F27B 9/2407; F27B 9/32

(57) ABSTRACT

A heat treatment system may include: a heat treatment furnace including an entrance, an exit, and an internal space through which a plurality of saggars is conveyed from the entrance toward the exit; and a return line located outside the heat treatment furnace and configured to convey the plurality of saggars from the exit to the entrance. The return line may include a first placement unit configured to allow the saggars to be placed thereon. The heat treatment system may include a movement device configured to move the first placement unit; and a first separator configured to separate a first space in which the first placement unit is located from a second space in which the movement device is located.

### REFERENCE TO RELATED APPLICATION

This application claims priority to Japanese Patent Application No. 2023-201726, filed on Nov. 29, 2023, the entire contents of which are hereby incorporated by reference into the present application.

### TECHNICAL FIELD

The disclosure herewith relates to heat treatment systems.

### BACKGROUND

Japanese Patent Application Publication No. 2022-150899 describes a continuous firing system. The continuous firing system includes a continuous firing furnace that fires material in saggars and a circulation line that circulates the saggars with respect to the continuous firing furnace. The circulation line includes a conveyor that conveys the saggars and a hood. The hood separates a circulation space extending from an exit to an entrance of the continuous firing furnace from an external space. A removal device that removes lids from the saggars and an inversion device that inverts the saggars are located in the circulation space.

### SUMMARY

Foreign matters such as wear particles may be generated due to the operations of the removal device and the inversion device. In the above heat treatment system, such foreign matters may enter the saggars since the removal device and the inversion device are located in the circulation space.

The disclosure herein provides technologies that suppress the entry of foreign matters into saggars.

In a first aspect of the art disclosed herein, a heat treatment system may comprise a heat treatment furnace including an entrance, an exit, and an internal space through which a plurality of saggars is conveyed from the entrance toward the exit; a return line located outside the heat treatment furnace and configured to convey the plurality of saggars from the exit to the entrance, the return line including a first placement unit configured to allow the saggars to be placed thereon; a movement device configured to move the first placement unit; and a first separator configured to separate a first space in which the first placement unit is located from a second space in which the movement device is located.

In the configuration above, the movement device is located in the second space different from the first space in which the saggars are located. Therefore, even when foreign matters such as wear particles are generated due to the operation of the movement device, the entry of the foreign matters into the first space can be suppressed. Thus, the above configuration suppresses the entry of foreign matters into the saggars.

In a seventh aspect of the art disclosed herein, a heat treatment system may comprise a heat treatment furnace including an entrance, an exit, and an internal space through which a plurality of saggars is conveyed from the entrance toward the exit; a return line located outside the heat treatment furnace and configured to convey the plurality of saggars from the exit to the entrance, the return line including a placement unit configured to allow the saggars to be placed thereon; an operation device configured to perform a predetermined operation to the saggars on the return line; and a separator configured to separate a first space in which the placement unit is located from a second space different from the first space. The operation device may comprise a cylinder rod configured to move toward and away from the saggars; and a cylinder body located in the second space and supports the cylinder rod such that the cylinder rod is slidable to the cylinder body. The cylinder body may be configured to drive the cylinder rod. A portion of the cylinder rod may be located in the first space.

In the configuration above, the cylinder body is located in the second space different from the first space in which the saggars are located. Therefore, even when foreign matters such as wear particles are generated due to the operation of the cylinder body, the entry of the foreign matters into the first space can be suppressed. Thus, the above configuration suppresses the entry of foreign matters into the saggars.

### BRIEF DESCRIPTION OF DRAWINGS

FIG. 1 schematically shows a heat treatment system according to an embodiment.

FIG. 2 shows a cross-sectional view of a conveyor and a saggar according to the embodiment.

FIG. 3 shows a cross-sectional view of the conveyor and the saggar according to the embodiment.

FIG. 4 schematically shows the conveyor, a lifter, a casing, and a conveyor cover as viewed in an up-down direction, according to the embodiment.

FIG. 5 schematically shows the conveyor, the lifter, the casing, and the conveyor cover as viewed in a direction perpendicular to a conveying direction and the up-down direction, according to the embodiment.

FIG. 6 shows a cross-sectional view of the conveyor, the lifter, and the casing according to the embodiment.

FIG. 7 shows a cross-sectional view of the conveyor, the lifter, and the casing according to the embodiment, where inlet and outlet shutters are in a closing position.

FIG. 8 shows a cross-sectional view of the conveyor, the lifter, the casing, and the conveyor cover according to the embodiment, where the inlet shutter is in an open position and the outlet shutter is in the closing position.

FIG. 9 shows a cross-sectional view of the conveyor, the lifter, the casing, and the conveyor cover according to the embodiment, where the inlet shutter is in the closing position and the outlet shutter is in an open position.

FIG. 10 shows a cross-sectional view of the conveyor, the conveyor cover, cylinders, and a roller actuator according to the embodiment, where a saggar is not held between the pair of cylinders.

FIG. 11 shows a cross-sectional view of the conveyor, the conveyor cover, the cylinders, and the roller actuator according to the embodiment, where a saggar is held between the pair of cylinders.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved heat treatment systems, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Some of the features characteristic to below-described embodiments will herein be listed. It should be noted that the respective technical elements are independent of one another, and are useful solely or in combinations. The combinations thereof are not limited to those described in the claims as originally filed.

In a second aspect of the art disclosed herein according to the above-mentioned first aspect, the first separator may be a casing fixed to the first placement unit and configured to cover the first placement unit. The movement device may be a lifter fixed to the casing and configured to lift and lower the casing. In this configuration, the first placement unit and the saggars on the first placement unit are covered by the casing (the first separator), while the lifter is located outside the casing. Therefore, even when foreign matters such as wear particles are generated by the lifter, the entry of the foreign matters into the casing can be suppressed. Thus, the above configuration suppresses the entry of foreign matters into the saggars.

In a third aspect of the art disclosed herein according to the above-mentioned second aspect, the first placement unit may comprise a plurality of rollers that are arranged in a first direction and allow the saggars to move in the first direction. The casing may comprise a body elongated in the first direction; an inlet located at one end of the body in the first direction; an outlet located at other end of the body in the first direction; an inlet shutter configured to open and close the inlet; and an outlet shutter configured to open and close the outlet. In the configuration above, the entry of foreign matters into the casing is suppressed by the inlet shutter closing the inlet and the outlet shutter closing the outlet. Thus, the configuration above suppresses the entry of foreign matters into the saggars.

In a fourth aspect of the art disclosed herein according to the above-mentioned first to third aspects, the return line may further comprise a second placement unit configured to allow the saggars to be placed thereon. The heat treatment system may further comprise an operation device configured to perform a predetermined operation to the saggars on the second placement unit; and a second separator. The operation device may comprise a cylinder rod configured to move toward and away from the saggars; and a cylinder body that supports the cylinder rod such that the cylinder rod is slidable to the cylinder body. The cylinder body may be configured to drive the cylinder rod. The second separator may be configured to separate a third space in which a portion of the cylinder rod is located from a fourth space in which the cylinder body is located. In this configuration, even when foreign matters such as wear particles are generated by the cylinder body driving the cylinder rod, the entry of the foreign matters into the third space is suppressed. Thus, the configuration above suppresses the entry of foreign matters into the saggars.

In a fifth aspect of the art disclosed herein according to the above-mentioned fourth aspect, the heat treatment system may further comprise a rod cover located in the third space and at least partially covering the cylinder rod. Foreign matters such as wear particles generated by the cylinder body may pass through a gap between the cylinder body and the cylinder rod. The configuration above suppresses such foreign matters that have passed through the gap between the cylinder body and the cylinder rod from escaping to the outside of the rod cover. Thus, the configuration above suppresses the entry of foreign matters into the saggars.

In a sixth aspect of the art disclosed herein according to the above-mentioned first to fifth aspects, a contact portion of the first placement unit may be configured to contact with the saggars and may be constituted of a resin material or ceramics. Foreign matters such as wear particles may be generated by the first placement unit while the saggars are moving on the first placement unit. If the first placement unit is constituted of a metal material, metal particles are generated and the quality of material to be heat treated would be deteriorated if the metal particles enter the saggars. In the configuration above, resin particles or ceramic particles are generated by the contact portion of the first placement unit. Thus, the configuration above suppresses the quality deterioration of material to be treated which is caused by the entry of foreign matters into the saggars, as compared to the configuration in which the first placement unit is constituted of a metal material.

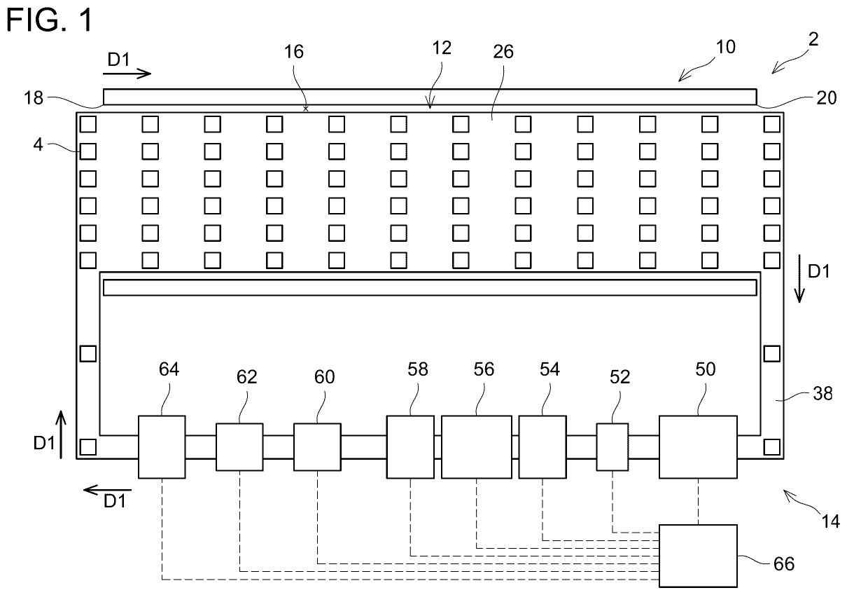

(Embodiment) As shown in FIG. 1, a heat treatment system 2 comprises a heat treatment furnace 10, a furnace conveyor device 12, and a return line 14.

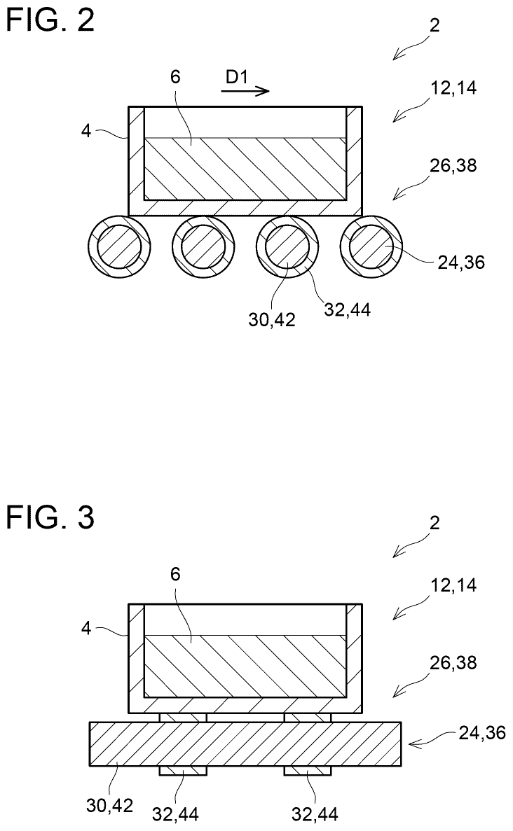

The heat treatment furnace 10 fires, i.e., heat treats material 6 (see FIG. 2) in saggars 4 by heat generated by heaters (not shown). The material 6 is for example a raw material for a ceramic capacitor, a positive-electrode material, or a negative-electrode material of a lithium ion battery.

The heat treatment furnace 10 is a heat insulating structure having a substantially cuboid shape. The heat treatment furnace 10 includes an internal space 16 therein. The heat treatment furnace 10 further includes an entrance 18 located at an end of the heat treatment furnace 10 and an exit 20 located at another end of the heat treatment furnace 10. The internal space 16 is in communication with the outside of the heat treatment furnace 10 via the entrance 18 and the exit 20.

The furnace conveyor device 12 is located in the internal space 16. The furnace conveyor device 12 is configured to allow the saggars 4 to be placed thereon. The furnace conveyor device 12 conveys the saggars 4 in a conveying direction D1. The saggars 4 are conveyed from the outside of the heat treatment furnace 10 into the internal space 16 through the entrance 18, conveyed within the internal space 16 from the entrance 18 toward the exit 20, and then conveyed out from the internal space 16 to the outside of the heat treatment furnace 10 through the exit 20.

As shown in FIG. 2, the furnace conveyor device 12 is a conveyor 26 comprising a plurality of rollers 24. Each roller 24 is rotatably supported at its opposing end portions. The saggars 4 are placed on the plurality of rollers 24. The rollers 24 are arranged in the conveying direction D1. Rotation of the rollers 24 moves the saggars 4 on the conveyor 26 in the conveying direction D1.

Each roller 24 comprises a non-contact portion 30 and one or more contact portions 32 (two contact portions 32 in this embodiment). The non-contact portion 30 is substantially cylindrical in shape. The non-contact portion 30 is constituted of a metal material, which increases the strength of the roller 24. In a variant, the non-contact portion 30 may be constituted of ceramics. The contact portions 32 each cover a part of the circumferential surface of the non-contact portion 30. As shown in FIG. 3, the two contact portions 32 are separated from each other. The contact portions 32 are constituted of a resin material or ceramics. The resin material is for example nylon, polyethylene, or polyether ether ketone. The ceramics is for example alumina or mullite. For example, the material of the contact portions 32 is the same as the material of the non-contact portion 30. The saggars 4 contact the contact portions 32 when moving on the conveyor 26, so that foreign matters such as resin particles or ceramic particles may be generated from the rollers 24. Even when these foreign matters contaminate the material 6 in the saggars 4, the quality deterioration of the material 6 is less as compared to when metal particles contaminate the material 6.

As shown in FIG. 1, the return line 14 is located outside the heat treatment furnace 10. The return line 14 conveys the saggars 4 from the exit 20 to the entrance 18 in the conveying direction D1.

As shown in FIG. 2, as with the furnace conveyor device 12, the return line 14 is a conveyor 38 comprising a plurality of rollers 36. Each roller 36 is rotatably supported at its opposing end portions. The saggars 4 are placed on the plurality of rollers 36. The rollers 36 are arranged in the conveying direction D1. Rotation of the rollers 36 moves the saggars 4 on the conveyor 38 in the conveying direction D1.

Each roller 36 comprises a non-contact portion 42 and one or more contact portions 44 (two contact portions 44 in this embodiment). The configuration of the non-contact portion 42 is substantially the same as that of the non-contact portion 30. The configuration of the contact portions 44 is substantially the same as that of the contact portions 32. Specifically, the contact portions 44 each cover a part of the circumferential surface of the roller 36. The saggars 4 contact the contact portions 44 when moving on the conveyor 38. For example, the material of the contact portions 44 is the same as the material of the contact portions 32. Thus, even when foreign matters such as resin particles or ceramics particles are generated from the contact portions 44 due to the conveyance of the saggars 4 and contaminate the material 6, the quality deterioration of the material 6 is less as compared to when metal particles contaminate the material 6.

As shown in FIG. 1, the heat treatment system 2 comprises a cooling device 50, a disintegration device 52, a first lifter 54, a recovery device 56, a second lifter 58, a cleaning device 60, a crack detection device 62, a supply device 64, and a controller 66. The cooling device 50, the disintegration device 52, the first lifter 54, the recovery device 56, the second lifter 58, the cleaning device 60, the crack detection device 62, and the supply device 64 are located on the return line 14 and arranged in this order from the upstream end of the return line 14 toward the downstream end thereof (i.e., along the conveying direction D1).

The cooling device 50 is configured to allow the saggars 4 to pass therethrough. The cooling device 50 cools the saggars 4 and the material 6 therein (see FIG. 2) by a coolant (e.g., air or water) flowing in one or more cooling pipes (not shown).

The disintegration device 52 disintegrates the material 6 for example by piercing one or more pins into the heat-treated material 6 (see FIG. 2) in the saggars 4.

The first lifter 54 lifts the saggars 4. In a variant, the first lifter 54 may lower the saggars 4. The configuration of the first lifter 54 will be described later in detail.

The recovery device 56 turns the saggars 4 upside down after the saggars 4 have been lifted by the first lifter 54. Thereby, the material 6 (see FIG. 2) is discharged from the saggars 4 and recovered.

The second lifter 58 lowers the saggars 4 after the material 6 has been discharged therefrom. In a variant, the second lifter 58 may lift the saggars 4 after the material 6 has been discharged therefrom. The configuration of the second lifter 58 will be described later in detail.

The cleaning device 60 cleans the saggars 4. Residual material 6 in the saggars 4 is thereby removed from the saggars 4.

The crack detection device 62 detects cracks and chips in the saggars 4.

The supply device 64 supplies the material 6 into the saggars 4.

The controller 66 controls the cooling device 50, the disintegration device 52, the first lifter 54, the recovery device 56, the second lifter 58, the cleaning device 60, the crack detection device 62, and the supply device 64. The controller 66 further controls the heat treatment furnace 10, the furnace conveyor device 12, the conveyor 26, and the conveyor 38.

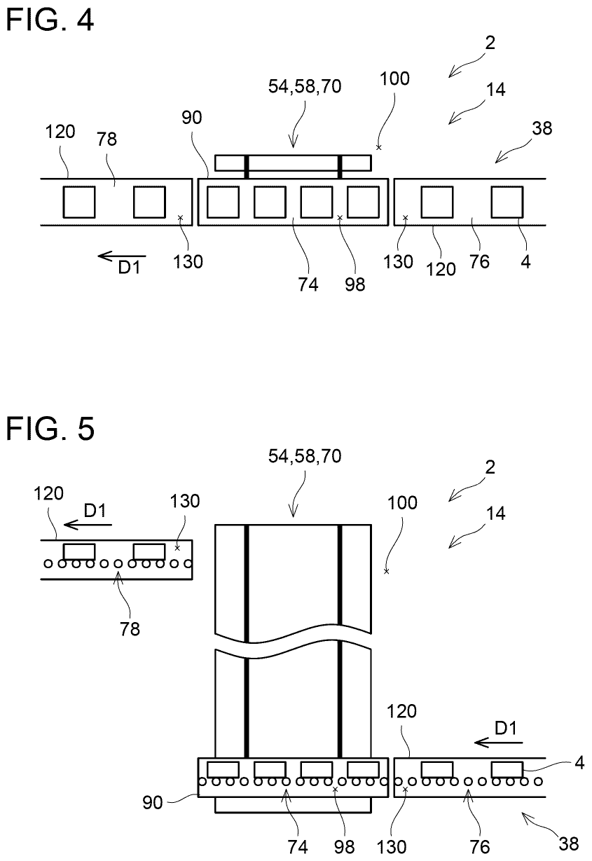

Referring to FIGS. 4 to 9, the first lifter 54 and the second lifter 58 are described. In this embodiment, the configuration of the first lifter 54 is substantially the same as that of the second lifter 58. Thus, the first lifter 54 and the second lifter 58 both may be termed a lifter 70.

First, the configuration of the conveyor 38 is described in detail. As shown in FIG. 4, the conveyor 38 comprises a lifter conveyor 74, an upstream conveyor 76, and a downstream conveyor 78. The lifter conveyor 74 is configured to allow multiple saggars 4 to be placed thereon. The lifter conveyor 74 is lifted and lowered by the lifter 70. The upstream conveyor 76 is located upstream of the lifter conveyor 74 on the return line 14. The downstream conveyor 78 is located downstream of the lifter conveyor 74 on the return line 14. The upstream conveyor 76 and the downstream conveyor 78 are each surrounded by a conveyor cover 120, which will be described later. As shown in FIG. 5, the position of the downstream conveyor 78 in an up-down direction is different from the position of the upstream conveyor 76 in the up-down direction. Specifically, in the case where the lifter 70 is the first lifter 54, the downstream conveyor 78 is positioned above the upstream conveyor 76. In a variant, in the case where the lifter 70 is the first lifter 54, the downstream conveyor 78 may be positioned below the upstream conveyor 76. In the case where the lifter 70 is the second lifter 58, the downstream conveyor 78 is positioned below the upstream conveyor 76. In a variant, in the case where the lifter 70 is the second lifter 58, the downstream conveyor 78 may be positioned above the upstream conveyor 76. The up-down direction herein is a direction perpendicular to the conveying direction D1.

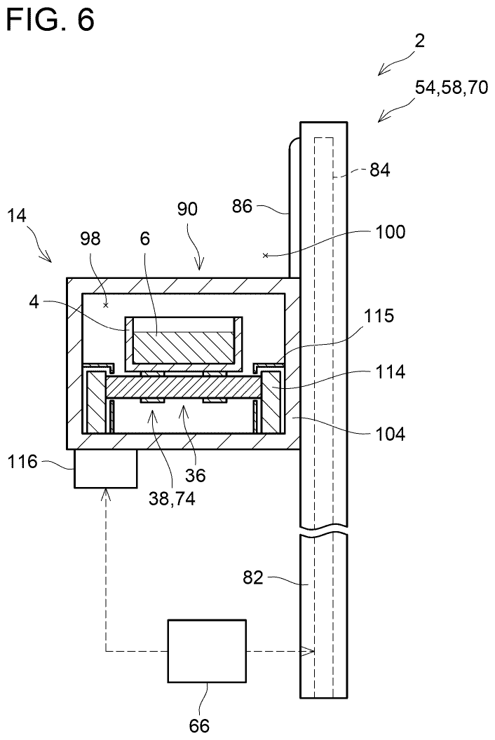

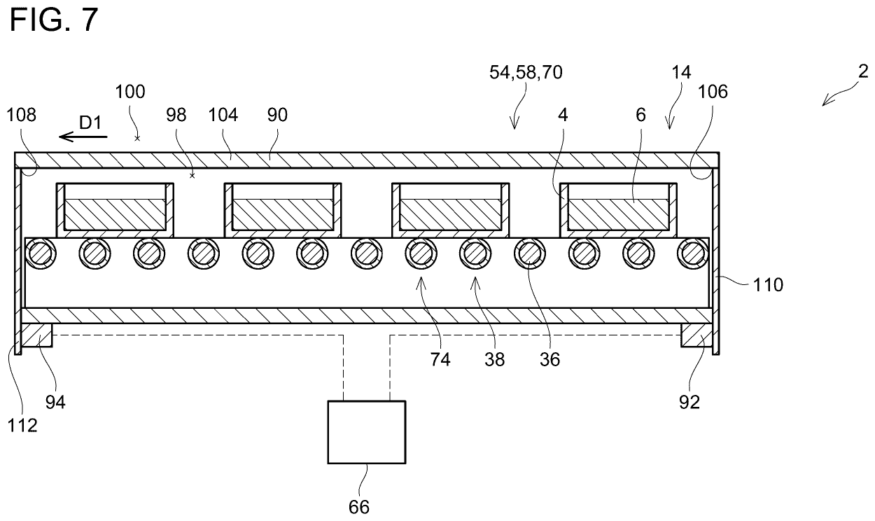

As shown in FIGS. 6 and 7, the lifter 70 comprises a lifter member 82 and an actuation member 84. The lifter member 82 comprises a chain 86. The lifter member 82 lifts and lowers an object (e.g., the lifter conveyor 74) by the chain 86 being actuated. The actuation member 84 actuates the chain 86. The actuation member 84 is controlled by the controller 66.

The heat treatment system 2 comprises a casing 90, an inlet shutter actuator 92, and an outlet shutter actuator 94.

The casing 90 includes an accommodation space 98 in which the lifter conveyor 74 and saggars 4 on the lifter conveyor 74 are accommodated. The casing 90 separates the accommodation space 98 from an external space 100 outside the casing 90. The lifter 70 is located in the external space 100. The casing 90 comprises a body 104, an inlet 106, an outlet 108, an inlet shutter 110, and an outlet shutter 112.

As shown in FIG. 6, the body 104 is attached to the lifter member 82 such that the body 104 is movable in the up-down direction. As shown in FIG. 7, the body 104 has a box shape elongated in the conveying direct D1. The body 104 supports the rollers 36 of the lifter conveyor 74 at their opposing end portions such that the rollers 36 are rotatable. As shown in FIG. 6, the rollers 36 are actuated by a roller actuator 116 via a transmission member 114. The transmission member 114 is located in the accommodation space 98. The transmission member 114 is surrounded by a transmission member cover 115. Thus, even when foreign matters such as wear particles are generated due to the actuation of the transmission member 114, the foreign matters are suppressed from escaping to the outside of the transmission member cover 115. This suppresses the entry of the foreign matters into the saggars 4. The roller actuator 116 is fixed to the body 104. The roller actuator 116 is located in the external space 100. The roller actuator 116 is controlled by the controller 66. FIGS. 7 to 9 omit the depiction of the roller actuator 116.

As shown in FIG. 7, the inlet 106 is located at an end of the body 104 in the conveying direction D1.

The outlet 108 is located at the other end of the body 104 in the conveying direction D1. The outlet 108 opposes the inlet 106.

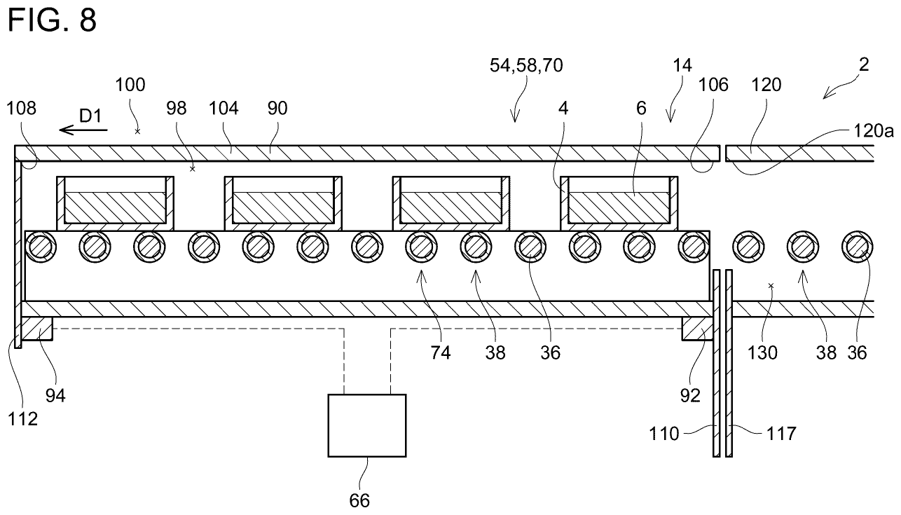

The inlet shutter 110 is located at the inlet 106. The inlet shutter 110 is attached to the body 104 so as to be movable in the up-down direction. The inlet shutter 110 moves between an open position (see FIG. 8) and a closing position. The inlet shutter 110 is configured to open and close the inlet 106. As shown in FIG. 8, the inlet shutter 110 opens the inlet 106 when it is in the open position. As shown in FIG. 7, the inlet shutter 110 closes the inlet 106 when it is in the closing position. When the inlet shutter 110 is in the closing position, the accommodation space 98 is not in communication with the external space 100 via the inlet 106.

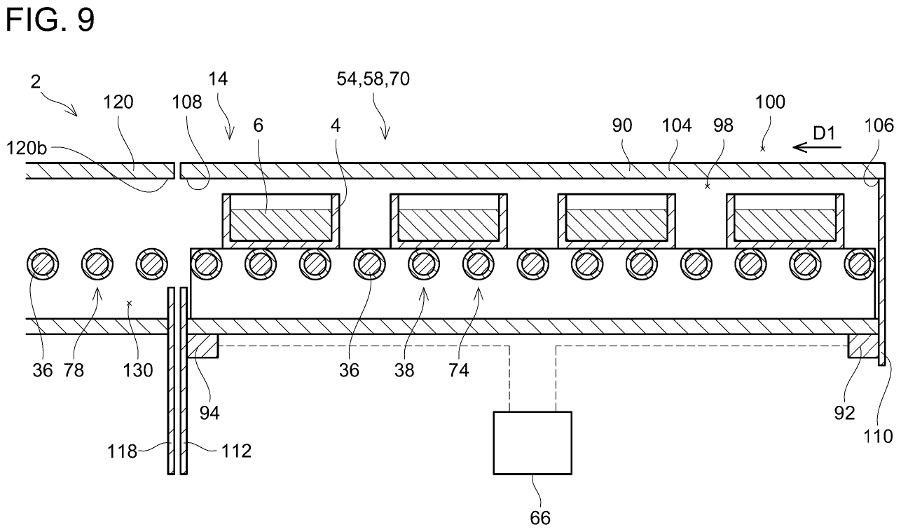

The outlet shutter 112 is located at the outlet 108. The outlet shutter 112 is attached to the body 104 so as to be movable in the up-down direction. The outlet shutter 112 moves between an open position (see FIG. 9) and a closing position. The outlet shutter 112 is configured to open and close the outlet 108. As shown in FIG. 9, the outlet shutter 112 opens the outlet 108 when it is in the open position. As shown in FIG. 7, the outlet shutter 112 closes the outlet 108 when it is in the closing position. When the outlet shutter 112 is in the closing position, the accommodation space 98 is not in communication with the external space 100 via the outlet 108.

The inlet shutter actuator 92 and the outlet shutter actuator 94 are fixed to the body 104. The inlet shutter actuator 92 and the outlet shutter actuator 94 are located in the external space 100 separated from the accommodation space 98. The inlet shutter actuator 92 moves the inlet shutter 110 between the open position and the closing position when the outlet shutter 112 is in the closing position. Thus, the inlet shutter 110 opens the inlet 106 when the outlet 108 is closed by the outlet shutter 112. The outlet shutter actuator 94 moves the outlet shutter 112 between the open position and the closing position when the inlet shutter 110 is in the closing position. Thus, the outlet shutter 112 opens the outlet 108 when the inlet 106 is closed by the inlet shutter 110.

How the saggars 4 are conveyed from the upstream conveyor 76 to the downstream conveyor 78 is described. First, as shown in FIG. 8, the inlet shutter actuator 92 moves the inlet shutter 110 from the closing position to the open position when the casing 90 faces the conveyor cover 120 surrounding the upstream conveyor 76 in the conveying direction D1. A shutter 117 is attached to the conveyor cover 120 surrounding the upstream conveyor 76 and is configured to open and close an outlet 120a of the conveyor cover 120. The shutter 117 opens the outlet 120a of the conveyor cover 120 when the inlet shutter 110 moves to the open position. Thereby, the accommodation space 98 communicates with the internal space of the conveyor cover 120 (i.e., a conveyor space 130 which will be described later) via the inlet 106 of the casing 90. Then, the rollers 36 of the upstream conveyor 76 and the rollers 36 of the lifter conveyor 74 rotate while the inlet shutter 110 is in the open position. Thereby, multiple saggars 4 are moved from the upstream conveyor 76 to the lifter conveyor 74 and thus placed in the accommodation space 98. Then, the inlet shutter actuator 92 moves the inlet shutter 110 from the open position to the closing position. As a result, the accommodation space 98 is no longer in communication with the external space 100 and the internal space of the conveyor cover 120 via the inlet 106 of the casing 90. The shutter 117 closes the outlet 120a of the conveyor cover 120 when the inlet shutter 110 moves to the closing position.

Then, as shown in FIG. 6, the actuation member 84 actuates the chain 86. The casing 90 is thereby lifted (or lowered), together with the lifter conveyor 74 and the saggars 4 thereon, to the position of the downstream conveyor 78 (see FIG. 9). Thereafter, as shown in FIG. 9, the outlet shutter actuator 94 moves the outlet shutter 112 from the closing position to the open position. A shutter 118 is attached to the conveyor cover 120 surrounding the downstream conveyor 78 and is configured to open and close an inlet 120b of the conveyor cover 120. The shutter 118 opens the inlet 120b of the conveyor cover 120 when the outlet shutter 112 moves to the open position. Thereby, the accommodation space 98 communicates with the internal space of the conveyor cover 120 (i.e., a conveyor space 130 which will be described later) via the outlet 108 of the casing 90. Then, the rollers 36 of the lifter conveyor 74 and the rollers 36 of the downstream conveyor 78 rotate. The multiple saggars 4 are thereby moved from the lifter conveyor 74 to the downstream conveyor 78 and thus placed in the internal space of the conveyor cover 120. Finally, the outlet shutter actuator 94 moves the outlet shutter 112 from the open position to the closing position. As a result, the accommodation space 98 is no longer in communication with the external space 100 and the internal space of the conveyor cover 120 via the outlet 108 of the casing 90. The shutter 118 closes the inlet 120b of the conveyor cover 120 when the outlet shutter 112 moves to the closing position.

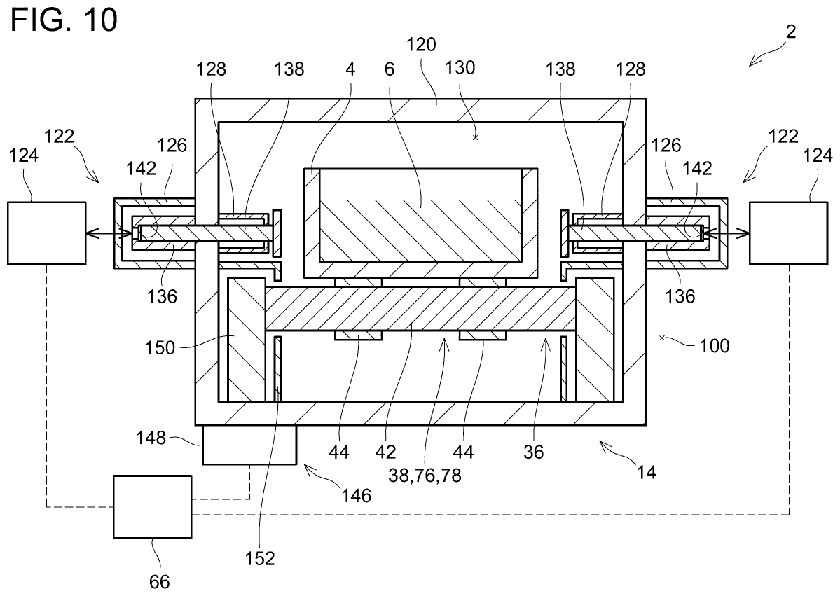

As shown in FIG. 10, the heat treatment system 2 further comprises the conveyor covers 120, pairs of cylinders 122, cylinder actuators 124, cylinder body covers 126, and rod covers 128.

Each of the conveyor covers 120 surrounds corresponding one of the upstream conveyor 76 and the downstream conveyor 78. The conveyor covers 120 each have a tunnel shape elongated in the conveying direction D1. The conveyor covers 120 have a conveyor space 130 in which the upstream conveyor 76 is located and a conveyor space 130 in which the downstream conveyor 78 is located. The conveyor spaces 130 correspond to the internal spaces of the conveyor covers 120. Each conveyor cover 120 separates its conveyor space 130 from the external space 100 outside the conveyor cover 120.

The pairs of cylinders 122 adjust the orientations of saggars 4. For example, on the return line 14, a pair of cylinders 122 is located upstream of each of the disintegration device 52, the first lifter 54, the recovery device 56, the second lifter 58, the cleaning device 60, the crack detection device 62, and the supply device 64. The pair of cylinders 122 is located near each of the disintegration device 52, the first lifter 54, the recovery device 56, the second lifter 58, the cleaning device 60, the crack detection device 62, and the supply device 64. Thus, the saggars 4 are conveyed, after their orientations have been adjusted, into/onto the disintegration device 52, the first lifter 54, the recovery device 56, the second lifter 58, the cleaning device 60, the crack detection device 62, and the supply device 64.

The cylinders 122 of each pair face each other in a right-left direction. The right-left direction herein is the direction perpendicular to the conveying direction D1 and the up-down direction. The saggars 4 move through between the cylinders 122 of each pair.

The cylinders 122 are for example air cylinders. In a variant, the cylinders 122 may be hydraulic cylinders. Each cylinder 122 comprises a cylinder body 136 and a cylinder rod 138.

The cylinder bodies 136 are fixed to the conveyor covers 120. The cylinder bodies 136 are located in the external space 100. Each cylinder body 136 includes an air port 142. The air ports 142 are located in the external space 100. The cylinder actuators 124 supply air into and remove air from the cylinder bodies 136 via the air ports 142. The cylinder actuators 124 are located in the external space 100. The cylinder actuators 124 are controlled by the controller 66.

The cylinder rods 138 are slidably supported by the cylinder bodies 136. The cylinder rods 138 extend through the conveyor covers 120. A portion (leading end portion) of each cylinder rod 138 is located in the conveyor spaces 130. The cylinder rods 138 are moved toward and away from the saggars 4 along an axial direction of the cylinder bodies 136 by air being supplied into and removed from the cylinder bodies 136 via the air ports 142.

The cylinder body covers 126 are fixed to the conveyor covers 120. The cylinder body covers 126 are located in the external space 100. The cylinder body covers 126 cover the entire cylinder bodies 136. Thus, each cylinder body 136 is located in a space between a corresponding cylinder body cover 126 and a conveyor cover 120. The cylinder body covers 126 suppress foreign matters such as dust from entering the conveyor spaces 130 through gaps between the cylinder bodies 136 and the conveyor covers 120.

The rod covers 128 are fixed to the conveyor covers 120. The rod covers 128 are located in the conveyor spaces 130. Each rod cover 128 covers a portion of a corresponding cylinder rod 138 (in the conveyor space 130, a portion closer to the cylinder body 136). Thus, the portion of each cylinder rod 138 is located in a space between a corresponding rod cover 128 and a conveyor cover 120. The rod covers 128 suppress foreign matters that have entered through gaps between the cylinder rods 138 and the conveyor covers 120 from reaching the material 6 in the saggars 4.

The return line 14 further comprises roller actuators 146. The roller actuators 146 rotate the rollers 36 of the upstream conveyor 76 and the rollers 36 of the downstream conveyor 78. Each roller actuator 146 comprises a roller actuation member 148 and a transmission member 150.

The roller actuation members 148 are located in the external space 100. The roller actuation members 148 are controlled by the controller 66.

The transmission members 150 are located in the conveyor spaces 130. Each transmission member 150 is surrounded by a transmission member cover 152. Thus, even when foreign matters such as wear particles are generated by the actuation of the transmission members 150, the foreign matters are suppressed from escaping to the outside of the transmission member covers 152. Therefore, the entry of the foreign matters into the saggars 4 is suppressed. Each transmission member 150 is connected to corresponding one of the roller actuation members 148. The transmission members 150 rotate the rollers 36 when the roller actuation members 148 operate.

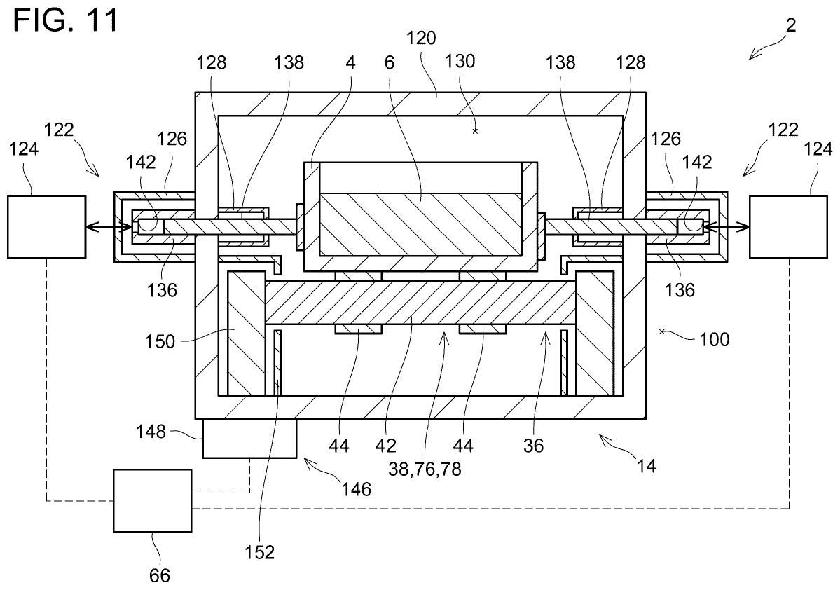

How the orientation of each saggar 4 is adjusted is described. First, when the roller actuation member 148 operates, the transmission member 150 rotates the rollers 36. The rotation of the rollers 36 moves the saggars 4 on the return line 14 (specifically, on the upstream conveyor 76 or on the downstream conveyor 78). When a saggar 4 comes between a pair of cylinders 122, the roller actuation member 148 stops operating and thus the rotation of the rollers 36 stops. Then, as shown in FIG. 11, the cylinder actuators 124 supply air into the cylinders 122 via the air ports 142. Thereby, the cylinder rods 138 advance (are moved) toward the saggar 4 and the saggar 4 is finally held between the cylinder rods 138. The orientation of the saggar 4 is thus adjusted to a predetermined orientation. Then, as shown in FIG. 10, the cylinder actuators 124 remove air from the cylinders 122 via the air ports 142. Thereby, the cylinder rods 138 retract (are moved away) from the saggar 4. Lastly, the roller actuation member 148 starts operating and thus the transmission member 150 starts rotating the rollers 36. The rotation of the rollers 36 moves the saggar 4 on the return line 14 (specifically, on the upstream conveyor 76 or on the downstream conveyor 78). As above, each saggar 4 is conveyed, after its orientation has been adjusted, into/onto the disintegration device 52, the first lifter 54, the recovery device 56, the second lifter 58, the cleaning device 60, the crack detection device 62, and the supply device 64.

(Advantageous Effects) In the embodiment above, the lifter conveyor 74 on which the saggars 4 are placed is located in the accommodation space 98 in the casing 90, while the lifter 70 moving the lifter conveyor 74 is located in the external space 100. Even when foreign matters such as wear particles are generated due to the operation of the lifter 70, the entry of the foreign matters into the accommodation space 98 is suppressed since the accommodation space 98 is separated from the external space 100. Thus, the entry of the foreign matters into the saggars 4 is suppressed.

The upstream conveyor 76 and the downstream conveyor 78 on which the saggars 4 are placed are located in the conveyor spaces 130, and the conveyor spaces 130 are separated from the external space 100 by the conveyor covers 120. For the cylinders 122 configured to adjust the orientations of the saggars 4, the cylinder bodies 136 are located in the external space 100 and portions of the cylinder rods 138 are located in the conveyor spaces 130. Thus, even when foreign matters such as wear particles are generated from the cylinder bodies 136 due to the cylinder bodies 136 actuating the cylinder rods 138, the entry of the foreign matters into the conveyor spaces 130 is suppressed. Thus, the entry of the foreign matters into the saggars 4 is suppressed.

(Correspondence Relationships) The lifter conveyor 74 is an example of “first placement unit”. The lifter 70 is an example of “movement device”. The casing 90 is an example of “separator”. The upstream conveyor 76 is examples of “second placement unit” and “placement unit”. The downstream conveyor 78 is examples of “second placement unit” and “placement unit”. The cylinders 122 are an example of “operation device”. The conveyor covers 120 are examples of “first separator” and “second separator”. The conveyor spaces 130 are examples of “first space” and “third space”. The external space 100 is examples of “second space” and “fourth space”.

(Variants) In an embodiment, the conveyors 26, 38 may be chain conveyors comprising chains.

In an embodiment, the cylinders 122 may be pushers configured to push the saggars 4.

Specific examples of the disclosure herein have been described in detail, however, these are mere exemplary indications and thus do not limit the scope of the claims. The art described in the claims includes modifications and variations of the specific examples presented above. Technical features described in the description and the drawings may technically be useful alone or in various combinations, and are not limited to the combinations as originally claimed. Further, the purpose of the examples illustrated by the present description or drawings is to satisfy multiple objectives simultaneously, and satisfying any one of those objectives gives technical utility to the present disclosure.

What is claimed is:

1. A heat treatment system comprising:
a heat treatment furnace including an entrance, an exit, and an internal space through which a plurality of saggars is conveyed from the entrance toward the exit;
a return line located outside the heat treatment furnace and configured to convey the plurality of saggars from the exit to the entrance, the return line including a first placement unit configured to allow the saggars to be placed thereon;
a movement device configured to move the first placement unit; and
a first separator configured to separate a first space in which the first placement unit is located from a second space in which the movement device is located.

2. The heat treatment system according to claim 1, wherein
the first separator is a casing fixed to the first placement unit and configured to cover the first placement unit, and
the movement device is a lifter fixed to the casing and configured to lift and lower the casing.

3. The heat treatment system according to claim 2, wherein
the first placement unit comprises a plurality of rollers that are arranged in a first direction and configured to allow the saggars to move in the first direction,
the casing comprises:
a body elongated in the first direction;
an inlet located at one end of the body in the first direction;
an outlet located at other end of the body in the first direction;
an inlet shutter configured to open and close the inlet; and
an outlet shutter configured to open and close the outlet.

4. The heat treatment system according to claim 1, wherein
the return line further comprises a second placement unit configured to allow the saggars to be placed thereon,
the heat treatment system further comprises:
an operation device configured to perform a predetermined operation to the saggars on the second placement unit; and
a second separator,
the operation device comprises:
a cylinder rod configured to move toward and away from the saggars; and
a cylinder body that supports the cylinder rod such that the cylinder rod is slidable and is configured to drive the cylinder rod, and
the second separator is configured to separate a third space in which a portion of the cylinder rod is located from a fourth space in which the cylinder body is located.

5. The heat treatment system according to claim 4, further comprising a rod cover located in the third space and at least partially covering the cylinder rod.

6. The heat treatment system according to claim 1, wherein a contact portion of the first placement unit is configured to contact with the saggars and is constituted of a resin material or ceramics.

7. A heat treatment system comprising:
a heat treatment furnace including an entrance, an exit, and an internal space through which a plurality of saggars is conveyed from the entrance toward the exit;
a return line located outside the heat treatment furnace and configured to convey the plurality of saggars from the exit to the entrance, the return line including a placement unit configured to allow the saggars to be placed thereon;
an operation device configured to perform a predetermined operation to the saggars on the return line; and
a separator configured to separate a first space in which the placement unit is located from a second space different from the first space,
wherein
the operation device comprises:
a cylinder rod configured to move toward and away from the saggars; and
a cylinder body located in the second space and supports the cylinder rod such that the cylinder rod is slidable and is configured to drive the cylinder rod, and
a portion of the cylinder rod is located in the first space.
